(19) United States
(12) Patent Application Publication
(10) Pub. No.: US 2012/0074630 A1
(43) Pub. Date: Mar. 29, 2012

(54) ANTI-VIBRATION BUSH

(75) Inventors: Kazuhiko KATO, Komaki-shi (JP); Michiharu HIKOSAKA, Komaki-shi (JP)

(73) Assignee: TOKAI RUBBER INDUSTRIES, LTD., Aichi-ken (JP)

(21) Appl. No.: 13/239,850

(22) Filed: Sep. 22, 2011

(30) Foreign Application Priority Data
Sep. 28, 2010 (JP) 2010-216504

(51) Int. Cl. B60G 11/22; F16F 1/38

(52) U.S. Cl. 267/292

(57) ABSTRACT

An anti-vibration bush has a pair of intermediate members harder than a main rubber elastic body, circumferentially extending for a predetermined length, and provided radially opposite to each other radially between an inner shaft member and an outer tubular member. The intermediate members are embedded in and attached to the main rubber elastic body. An axial size of an end surface on the inner shaft member side of each of the intermediate members is larger than an axial size of an end surface on the outer tubular member side of each of the intermediate members.

### CROSS-REFERENCE TO RELATED APPLICATIONS

The present application claims priority under 35 U.S.C. §119 of Japanese Application No. 2010-216504, filed on Sep. 28, 2010, which is herein expressly incorporated by reference in its entirety.

### BACKGROUND OF THE INVENTION

1. Field of the Invention

The present invention relates to an anti-vibration bush used in a suspension mechanism of an automobile.

2. Description of Related Art

Conventionally, an anti-vibration bush is used for vibration isolation and connection of a suspension arm and a vehicle body of an automobile, for example. Such an anti-vibration bush has a structure in which an inner shaft member and an outer tubular member disposed external thereto are elastically connected by a main rubber elastic body. Japanese Utility Model Laid-Open Publication No. H4-111933 (Related Art 1) discloses such an example.

In order to improve running stability of an automobile, it is sometimes required to increase a spring constant in a direction perpendicular to the axis of the anti-vibration bush. As disclosed in Related Art 1, a proposed method is to insert an intermediate member harder than the main rubber elastic body into a space between radially facing surfaces of the inner shaft member and the outer tubular member and to attach the intermediate member to the main rubber elastic body. According to the method, the thickness is reduced in the radial direction of the main rubber elastic body and the spring is hardened in the radial direction, thus improving running stability.

In the case of using the intermediate member as shown in Related Art 1, however, the intermediate member projects outward more than an axial end surface of the main rubber elastic body, thus reducing a free length of the axial end surface of the main rubber elastic body. As the inner shaft member and the outer tubular member are relatively tilted and a force in a bending direction exerted on the main body rubber elastic body, a crack may thus be caused in the attachment portion of the intermediate member on the axial end surface of the main rubber elastic body.

Japanese Utility Model Laid-Open Publication No. H5-47306 (Related Art 2) proposes a structure in which a radially externally bulging projection is provided in an inner shaft member in an attachment portion to a main rubber elastic body. The structure ensures free lengths of two axial end surfaces of the main rubber elastic body, thus securing durability to some extent to the input of a force in a bending direction. In this structure, however, a spring in a circumferential direction (torsional direction) is relatively large to a spring in a direction perpendicular to the axis. It is thus difficult in some cases to tune the hard spring in the direction perpendicular to the axis and the soft spring in the torsional direction according to required properties.

[Related Art 1] Japanese Utility Model Laid-Open Publication No. H4-111933

[Related Art 2] Japanese Utility Model Publication No. H5-47306

### SUMMARY OF THE INVENTION

In view of the circumstances above, the present invention provides an anti-vibration bush having a novel structure that achieves excellent durability to the input in a bending direction and that allows setting of a spring in a direction perpendicular to an axis and a spring in a torsional direction with a great flexibility.

A first aspect of the present invention provides an anti-vibration bush having an inner shaft member and an outer tubular member disposed external to the inner shaft member, the inner shaft member and the outer tubular member being connected by a main rubber elastic body, the anti-vibration bush including a pair of intermediate members harder than the main rubber elastic body, circumferentially extending for a predetermined length, and provided radially opposite to each other radially between the inner shaft member and the outer tubular member. The intermediate members are embedded in and attached to the main rubber elastic body. An axial size of an end surface on the inner shaft member side of each of the intermediate members is larger than an axial size of an end surface on the outer tubular member of each of the intermediate members.

In the anti-vibration bush having the structure according to the first aspect of the present invention, the intermediate members are disposed radially between the inner shaft member and the outer tubular member, thus limiting the thickness in a direction perpendicular to the axis of the main rubber elastic body. Accordingly, a spring constant in the direction perpendicular to the axis can be effectively set to be large without increasing the axial size of the main rubber elastic body. In a case of application to a suspension mechanism, for example, running stability can be improved.

In addition, the intermediate members each have the axial size of the end portion on the inner shaft member side (internal peripheral portion) larger than the axial size of the end portion on the outer tubular member side (external peripheral portion). At vibration input in the direction perpendicular to the axis, the difference of pressure reception areas due to the difference in the circumferential lengths is thus reduced between the internal peripheral surface and the external peripheral surface of each of the intermediate members, and a large pressure is prevented from being exerted locally on the main rubber elastic body.

The intermediate members are elastically supported by the main rubber elastic body and are relatively displaceable to the inner shaft member and the outer tubular member. To the input in a torsional direction, the spring is prevented from being hardened in the torsional direction, caused by the placement of the intermediate members. Accordingly, the anti-vibration bush of the present invention applied to a suspension bush, for example, tolerates vertical movement of wheels to improve ride comfort and facilitates assembly of a suspension to a body.

Thereby, the anti-vibration bush according to the present aspect allows setting of the spring in the direction perpendicular to the axis and the spring in the torsional direction with a greater flexibility, thus achieving required spring properties in a more sophisticated manner.

Furthermore, the intermediate members, which are embedded in and attached to the main rubber elastic body, are prevented from binding the axial end surface of the main rubber elastic body, thus ensuring a free length of the axial end surface of the main rubber elastic body to a large extent. Thereby, the durability of the main rubber elastic body is improved to the input in the bending direction.

In addition, the intermediate members, which are elastically supported by the main rubber elastic body, are axially displaced according to deformation of the main rubber elastic body as the inner shaft member and the outer tubular member are relatively tilted due to the input in the bending direction. Specifically, the intermediate members are axially displaced from a side to which the main rubber elastic body is radially compressed (side on which the inner shaft member and the outer tubular member approach each other in the radial direction) to a side from which the main rubber elastic body is radially pulled (side on which the inner shaft member and the outer tubular member are distanced from each other in the radial direction). Thereby, the strain on the main rubber elastic body due to the input in the bending direction is reduced, and thus the durability of the main rubber elastic body is further improved.

A second aspect of the present invention provides the anti-vibration bush according to the first aspect, in which, in the main rubber elastic body, a radial size of a portion between the inner shaft member and the intermediate member is larger than a radial size of a portion between the outer tubular member and the intermediate member.

According to the second aspect, in the main rubber elastic body, the radial size of the internal peripheral portion having a shorter circumferential length is larger than the radial size of the external peripheral portion having a longer circumferential length. Thus, deformation of the internal peripheral portion is dominant in a case of the displacement input in the torsional direction, thus reducing deformation of the external peripheral portion. Accordingly, strain is reduced in the external peripheral portion of the main rubber elastic body, where a rubber deformation amount is generally increased due to the displacement input in the torsional direction, and thus the durability is improved.

A third aspect of the present invention provides the anti-vibration bush according to one of the first and second aspects, in which the pair of intermediate members are each provided with a support in a position circumferentially out of a mutually opposing radial line and exposed externally from the main rubber elastic body, the support supporting in positioning the intermediate member in molding of the main rubber elastic body.

According to the third aspect, the support exposed externally from the main rubber elastic body is provided in the position circumferentially out of the virtual radial line extending in the opposing direction of the pair of intermediate members. As the inner shaft member and the outer tubular member are relatively tilted in the opposing radial direction of the pair of the intermediate members, the stress in the bending direction input to the main rubber elastic body is prevented from being intensively exerted on the attachment portion of the support, and thus defects can be prevented, including cracks in the main rubber elastic body.

A fourth aspect of the present invention provides the anti-vibration bush according to one of the first to third aspects, in which an axial length of the main rubber elastic body is greater in an internal peripheral portion than in an external peripheral portion.

According to the fourth aspect, the axial length of the main rubber elastic body is greater in the internal peripheral portion than in the external peripheral portion, similar to the intermediate members, thus reducing a change in the thickness in a portion of the main rubber elastic body that covers the axial end surfaces of the intermediate members. Accordingly, a substantial free length of the axial end surface of the main rubber elastic body is ensured without increasing the axial size of the main rubber elastic body more than necessary, thus improving the durability of the main rubber elastic body in the compact anti-vibration bush.

According to the present invention, the intermediate members are disposed radially between the inner shaft member and the outer tubular member, and thereby the difference can be set to be large between the springs in the direction perpendicular to the axis and in the torsional direction. Furthermore, the intermediate members each have the axial size less than the axial size between the end surfaces of the main rubber elastic body, thereby ensuring a free length on the axial end surface of the main rubber elastic body and preventing a decline in the durability of the main rubber elastic body.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a vertical cross-sectional view of a suspension bush according to a first embodiment of the present invention, the view corresponding to a cross section along I-I of FIG. 3;

FIG. 2 is another vertical cross-sectional view of the suspension bush shown in FIG. 1, the view corresponding to a cross section along II-II of FIG. 3;

FIG. 3 is a front view of the suspension bush shown in FIG. 1;

FIG. 4 is a cross-sectional view of FIG. 1 along IV-IV;

FIG. 5 is an enlarged view of a main portion of the suspension bush shown in FIG. 1;

FIG. 6 is a vertical cross-sectional view of a suspension bush according to a second embodiment of the present invention, the view corresponding to a cross section along VI-VI of FIG. 7; and

FIG. 7 is a front view of the suspension bush shown in FIG. 6.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are explained in detail below with reference to the drawings.

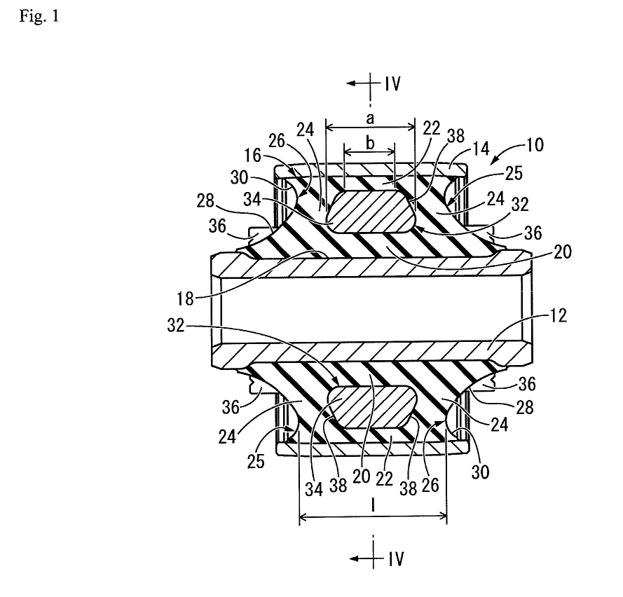

In FIGS. 1 to 4, a suspension bush 10 for an automobile is illustrated as an anti-vibration bush having a structure according to a first embodiment of the present invention. The suspension bush 10 has an inner shaft member 12 and an outer tubular member 14 disposed external to the inner shaft member 12. The inner shaft member 12 and the outer tubular member 14 are elastically connected by a main rubber elastic body 16. The inner shaft member 12 is mounted on a vehicle body (not shown in the drawings), while the outer tubular member 14 is mounted on an arm eye of a suspension arm (not shown in the drawings). Thereby, the suspension arm is connected with the vehicle body while being isolated from vibration therefrom.

More specifically, the inner shaft member 12 has a substantially cylindrical shape having a thick small diameter. The inner shaft member 12 is a highly rigid member composed of iron, an aluminum alloy, or the like. An attachment groove 18 is provided in an axially central portion of the inner shaft member 12, the attachment groove 18 being open to an external peripheral surface, continuously extending along the entire periphery, and having a wide width and a shallow depth. An external diameter of the inner shaft member 12 is reduced in a portion in which the attachment groove 18 is provided. The inner shaft member 12 has a substantially constant internal diameter along the entire length and is thinner in the portion of the attachment groove 18 than in two end sides axially outward therefrom.

The outer tubular member 14 has a thin trapezoidal and substantially cylindrical shape and has a smaller axial size than the inner shaft member 12. In the present embodiment in particular, the axial size of the outer tubular member 14 is smaller than the axial width of the attachment groove 18 in the inner shaft member 12.

The outer tubular member 14 is disposed external to the inner shaft member 12, and the inner shaft member 12 and the outer tubular member 14 are disposed opposite to each other having a substantially constant distance in the radial direction and are connected by the main rubber elastic body 16 provided between opposing surfaces thereof. The inner shaft member 12 and the outer tubular member 14 are disposed on the same central axis and to have the same axial center. The inner shaft member 12 projects on two axial sides from the outer tubular member 14 for the same length. The entirety of the outer tubular member 14 is disposed opposite to the bottom surface of the attachment groove 18 in the inner shaft member 12. Thereby, the radial size of the main rubber elastic body 16 is increased for the depth of the attachment groove 18 without increasing the external diameter of the main rubber elastic body 16.

The main rubber elastic body 16 is a rubber elastic body having a thick and substantially cylindrical shape. An internal peripheral surface thereof is vulcanized to the external peripheral surface of the inner shaft member 12 including the bottom surface of the attachment member 18, and an external peripheral surface thereof is vulcanized to the internal peripheral surface of the outer tubular member 14. Thereby, the main rubber elastic body 16 is integrated into a vulcanized molding having the inner shaft member 12 and the outer tubular member 14. The axial size of the internal peripheral surface of the main rubber elastic body 16 is slightly larger than the axial width of the attachment groove 18. The two axial ends of the internal peripheral surface of the main rubber elastic body 16 are vulcanized to portions axially outward from the attachment groove 18.

The main rubber elastic body 16 has an internal peripheral portion 20 on the inner shaft member 12 side and an external peripheral portion 22 on the outer tubular member 14 with a main body 34 of an intermediate member 32 hereinafter described in between. Two axial sides having the main body 34 therebetween are covered portions 24. The main rubber elastic body 16 has a tapered shape gradually tilting axially outward toward the internal periphery as a whole. The axial size of the internal peripheral portion 20 is larger than the axial size of the external peripheral portion 22.

The main rubber elastic body 16 also has an annular peripheral groove 25 open to the axial end surface and extending in the circumferential direction. The peripheral groove 25 has a curved cross section smoothly connecting a side wall surface and a bottom wall surface. The deepest portion 26 is radially biased toward the outer tubular member 14 and is positioned in a radially intermediate portion of the main rubber elastic body 16. With the peripheral groove 25 provided, the axial end surface of the main rubber elastic body 16 shares the internal periphery from the inner shaft member 12 to the deepest portion 26 of the peripheral groove 25 with an internal tapered surface 28 tilting axially inward toward the radial exterior, and the external periphery from the deepest portion 26 of the peripheral groove 25 to the outer tubular member 14 with an external tapered surface 30 tilting axially outward toward the radial exterior. The peripheral groove 25 is provided on each of the two axial sides of the main rubber elastic body 16. The two axial side surfaces have a substantially identical shape.

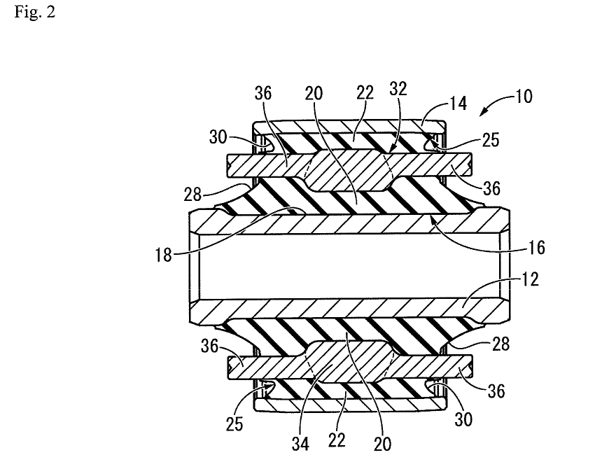

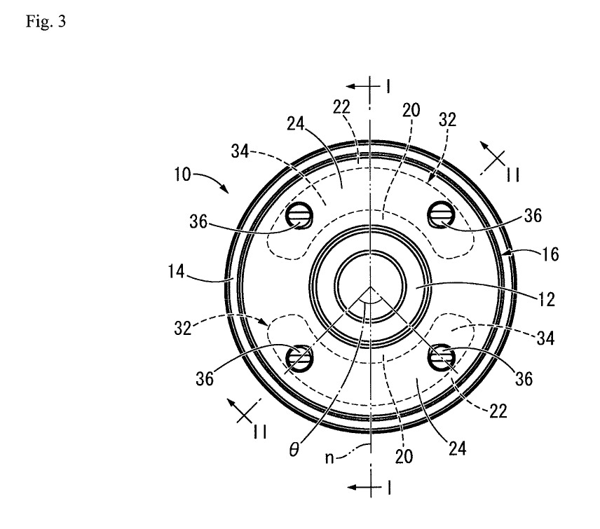

The intermediate member 32 is attached to the main rubber elastic body 16. The intermediate member 32, which is a member harder than the main rubber elastic body 16, is integrally provided with the main body 34 and a support projection 36, as shown in FIGS. 2 and 3, the main body 34 circumferentially extending for a predetermined length of less than a semi-perimeter, the support projection 36 axially projecting from the main body 34 as a support. A material of the intermediate member 32 is not particularly limited. Preferred materials may include, for example, metal materials, such as an aluminum alloy, hard synthetic resin materials, and rubber elastic bodies harder than the main rubber elastic body 16. To compare the hardness of the intermediate member 32 and the main rubber elastic body 16, general hardness tests may be employed to measure the hardness, including, for example, a Brinell hardness test, a Vickers hardness test, a Rockwell hardness test, a Durometer hardness test, and an international rubber test.

The main body 34 has a substantially constant isosceles trapezoidal shape from a cross section view. The main body 34 is provided radially between the inner shaft member 12 and the outer tubular member 14 and is embedded and vulcanized into the axially central portion of the main rubber elastic body 16. The main body 34 has the axial size (a) of the end surface (internal peripheral surface) on the inner shaft member 12 larger than the axial size (b) of the end surface (external peripheral surface) on the outer tubular member 14 (a>b). The main body 34 thus has tapered surfaces 38 which are two axial end surfaces tapered axially inward toward the radial exterior.

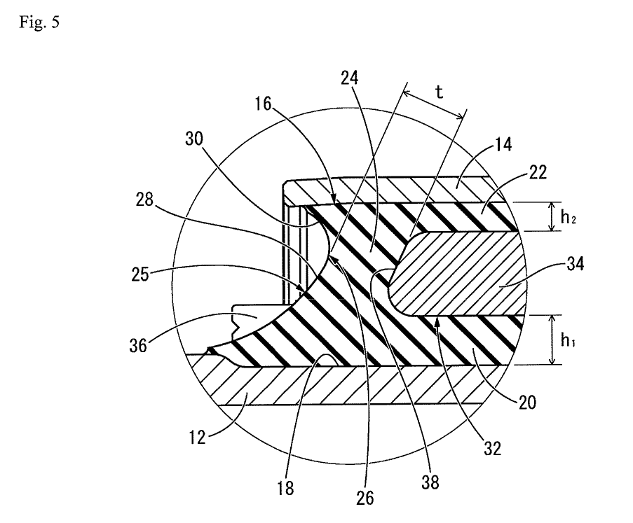

Each of the tapered surfaces 38 spreads substantially in parallel with the internal tapered surface 28 defining the axial end surface of the main rubber elastic body 16. The covered portion 24 positioned on the axial exterior of the main body 34 in the main rubber elastic body 16 has a substantially constant thickness (t) (Refer to FIG. 5). To prevent concentration of stress, the covered portion 24 of the main rubber elastic body 16 preferably has the substantially constant thickness. Even in the case where the thickness varies, the maximum thickness is preferably 200% or less of the minimum thickness, more preferably 150% or less. In the present embodiment, the entirety of the covered portion 24 has the substantially constant thickness, which is set to 3 mm or greater.

The main body 34 is integrally provided with the support projection 36. The support projection 36 has a solid rod shape having a small diameter. Four support projections 36 project from two circumferential end portions of the main body 34 toward two axial sides. A lock groove is open in a projection end surface of each of the support projections 36, the lock groove extending in the radial direction of each of the support projections 36.

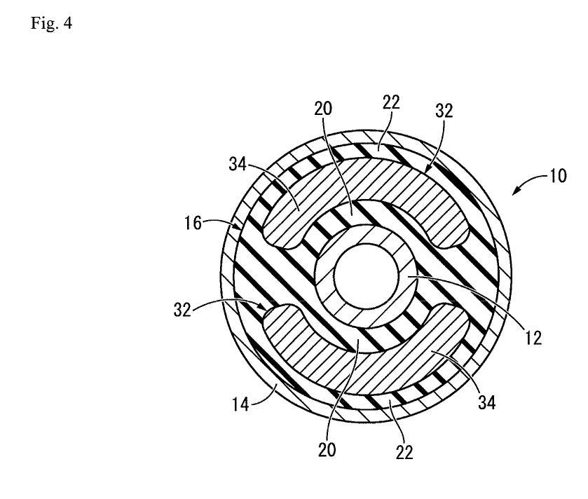

A pair of intermediate members 32 having such a structure are provided on two sides of the inner shaft member 12 in between. More specifically, the main body 34 of the intermediate member 32 is disposed between radially facing surfaces of the inner shaft member 12 and the outer tubular member 14 while being separated from any portion of the inner shaft member 12 and the outer tubular member 14, as shown in FIG. 4. The main body 34 is embedded and vulcanized in the main rubber elastic body 16. Thus, a substantially entire surface of the main body 34 of the intermediate member 32 is covered by the main rubber elastic body 16. In particular, the covered portion 24 of the main rubber elastic body 16 is vulcanized and attached to the tapered surface 38, which is the axial end surface.

As shown in FIG. 1, the maximum axial size (a) of the main body 34 is smaller than the minimum axial size (1) (distance between the deepest portions 26) of the main rubber elastic body 16 (a<1). In a projection in the direction perpendicular to the axis, the two axial end portions of the main rubber elastic body 16 are provided axially outside of the main body 34.

The main body 34 is radially biased toward the outer tubular member 14. In the main rubber elastic body 16, as shown in FIG. 5, the thickness (h₁) of the internal peripheral portion 20 is greater than the thickness (h₂) of the external peripheral portion 22 (h₁>h₂), the internal peripheral portion 20 being provided radially between the external peripheral surface of the inner shaft member 12 and the internal peripheral surface of the main body 34, the external peripheral portion 22 being provided radially between the external peripheral surface of the main body 34 and the internal peripheral surface of the inner shaft member 12.

As shown in FIG. 2, the four support projections 36 of the intermediate member 32 pass through the axial end surfaces of the main rubber elastic body 16 and project axially outward to be exposed to the exterior. The support projections 36 are positioned axially proximate to the deepest portions 26 of the peripheral groove 25, thus efficiently securing the projection height of the support projections 36 from the main rubber elastic body 16.

As shown in FIG. 3, the four support projections 36 are disposed on the two sides circumferentially out of a virtual radial line (line (n) indicated with a dashed-two dotted line in FIG. 3) extending in the opposing direction of a pair of intermediate members 32. An angle θ (refer to FIG. 3) defined by the support projections 36 provided on the two circumferential sides of the intermediate member 32 is preferably 45° or greater, more preferably 90° or greater. In the case where a force in a bending direction is input in the opposing direction of the pair of intermediate members 32, the force exerted on the support projections 36 is reduced, and cracks can be prevented from being caused in the attachment portions to the support projections 36 in the main rubber elastic body 16. The angle θ is thus set to slightly greater than 90°.

The suspension bush 10 is formed by, for example, setting the inner shaft member 12, the outer tubular member 14, and the pair of intermediate members 32 which are prepared in advance into a mold for molding the main rubber elastic body 16; filling a rubber material into a cavity of the mold; and vulcanizing the main rubber elastic body 16. In this process, the four support projections 36 of the intermediate member 32 are supported by the mold, and thereby the main body 34 is positioned in a predetermined position in the cavity.

In the suspension bush 10 having such a structure, the intermediate member 32 is disposed radially between the inner shaft member 12 and the outer tubular member 14 and is attached to the main rubber elastic body 16, thus allowing a spring constant to be set high in the direction perpendicular to the axis of the main rubber elastic body 16. Thereby, running performance of an automobile, including running stability, can be improved.

Furthermore, the axial size (a) of the internal peripheral end portion is greater than the axial size (b) of the external peripheral end portion. At the time of vibration input in the direction perpendicular to the axis, a significantly high stress is thus prevented from being exerted on the internal peripheral surface of the intermediate member 32 having a short periphery, thereby enhancing durability.

The suspension bush 10 can reduce the spring in the torsional direction while ensuring the spring in the direction perpendicular to the axis. Specifically, the intermediate member 32 is elastically supported through the main rubber elastic body 16 relative to both of the inner shaft member 12 and the outer tubular member 14, and is allowed to be relatively displaced with respect to the inner shaft member 12 and the outer tubular member 14 in the circumferential direction. Accordingly, the intermediate member 32 prevents the main rubber elastic body 16 from twisting and deforming at the input of load in the torsional direction, thereby lowering the spring property in the torsional direction.

In particular, the intermediate member 32 has a substantially semi-annular shape curving at substantially the same curvature as the inner shaft member 12 and the outer tubular member 14. Thus, a binding force partially strong on the circumference is prevented from being exerted on the intermediate member 32, thereby effectively reducing the spring in the torsional direction.

With these components, the hard spring in the direction perpendicular to the axis and the soft spring in the torsional direction are concurrently achievable in the suspension bush 10. The spring in the direction perpendicular to the axis and the spring in the torsional direction can be adjusted and set with a greater flexibility according to required properties.

The suspension bush 10 has an improved durability to the input in a bending direction. Specifically, the intermediate member 32 is attached to the main rubber elastic body 16 in an embedded state, and a free length is ensured to a great degree on the axial end surface of the main rubber elastic body 16. Thereby, defects are prevented, such as a crack in the axial end surface of the main rubber elastic body 16 due to the input in the bending direction, and thus the durability is improved.

In addition, as the main rubber elastic body 16 is elastically deformed due to the input in the bending direction, the intermediate member 32 elastically supported by the main rubber elastic body 16 is axially displaced, and thereby strain exerted on the main rubber elastic body 16 is released. More specifically, as the load is input in the bending direction, the main rubber elastic body 16 is compressed substantially radially on a first axial side on which the inner shaft member 12 and the outer tubular member 14 approach each other; and the main rubber elastic body 16 is pulled substantially radially on a second axial side on which the inner shaft member 12 and the outer tubular member 14 are distanced from each other. Thus, deformation of the main rubber elastic body 16 exerts on the intermediate member 32 the force traveling from the first axial side to the second axial side. Since the intermediate member 32 is elastically supported by the main rubber elastic body 16, the intermediate member 32 is axially displaced by the force exerted by the main rubber elastic body 16. Thus, the deformation of the main rubber elastic body 16 is sufficiently tolerated, thus reducing the strain and improving the durability.

In particular, the pair of intermediate members 32 are disposed opposite to each other having a predetermined distance in the radial direction of the load input in the bending direction. The pair of intermediate members 32 are independent from each other and relatively displaceable. Thus, the strain of the rubber or stress concentration at the time of load input is reduced and the durability is improved. For example, as the intermediate members 32 are axially displaced due to the input in the bending direction, one intermediate member 32 and the other intermediate member 32 are displaced to sides axially opposite to each other, thus reducing the strain of the main rubber elastic body 16. At this time, the pair of intermediate members 32 are disposed separately as separate bodies and are displaced independently. Thereby, tilting is restricted compared to an annular intermediate member and axial displacement is generated efficiently. Accordingly, the strain on the main rubber elastic body 16 is effectively reduced and the durability of the main rubber elastic body 16 is improved.

Furthermore, each of the main rubber elastic body 16 and the intermediate members 32 has the axial size of the internal peripheral portion greater than the axial size of the external peripheral portion. Thus, the thickness is substantially constant and sufficient in a portion (covered portion 24) of the main rubber elastic body 16 which is attached to the tapered surface 38 of the intermediate member 32. Thereby, the binding force of the intermediate member 32 exerted on the axial end surface of the main rubber elastic body 16 is reduced, thus ensuring a substantial free length of the axial end surface of the main rubber elastic body 16 and effectively improving the durability of the main rubber elastic body 16.

Furthermore, the projection of the support projection 36 is positioned circumferentially out of the input direction of the load that displaces the inner shaft member 12 and the outer tubular member 14 in the bending direction. Thus, the stress exerted on the attachment portion of the main rubber elastic body 16 to the support projection 36 is reduced. Thereby, cracks can be prevented from being caused in the attachment portion of the support projection 36 of the main rubber elastic body 16, thus improving the durability.

In addition, the covered portion 24 of the main rubber elastic body 16 is attached to the intermediate member 32 at a substantially constant thickness, thus reducing a change in the thickness. Accordingly, a rubber layer having a sufficient thickness is provided on the tapered surface 38 of the intermediate member 32 without enlarging the axial size of the main rubber elastic body 16 more than necessary, thus preventing axial expansion.

In addition, preventing axial expansion of the main rubber elastic body 16 is considered to contribute to improvement in durability to the load input in the bending direction. Specifically, cracks, which are caused as tensile stress is exerted on the axial end surface of the main rubber elastic body 16, are problems at the time of load input in the bending direction. Since the main rubber elastic body 16 having the small axial size is provided in the axially central portion of the inner shaft member 12 and the outer tubular member 14, the deformation amount of the axial end surface of the main rubber elastic body 16 can be relatively small. Accordingly, the tensile stress exerted on the axial end surface of the main rubber elastic body 16 is reduced, thus improving the durability.

In the internal peripheral portion 20 and the external peripheral portion 22 positioned on two radial sides having the intermediate member 32 therebetween of the main rubber elastic body 16, the radial size (h₁) of the internal peripheral portion 20 is greater than the radial size (h₂) of the external peripheral portion 22 (refer to FIG. 5). This further improves the durability of the main rubber elastic body 16. Specifically, when an inner shaft member and an outer tubular member of an anti-vibration bush are relatively twisted and displaced, an external peripheral portion of a main rubber elastic body generally tends to deform larger in the circumferential direction than an internal peripheral portion. In the suspension bush 10, however, the external peripheral portion 22 is radially thinner than the internal peripheral portion 20 of the main rubber elastic body 16. The spring is thus relatively large in the torsional direction of the external peripheral portion 22, causing sufficiently large deformation in the internal peripheral portion 20 at the time of load input in the torsional direction. Accordingly, the entirety of the main rubber elastic body 16 is deformed in the torsional direction in the substantially same manner, thereby preventing an increase in local stress in the main rubber elastic body 16 and improving the durability.

It is demonstrated in experiments that the suspension bush 10 achieves the high spring constant in the direction perpendicular to the axis, the low spring constant in the torsional direction, and the excellent durability to the input in the bending direction. Specifically, according to the experimental results, the suspension bush 10 of the present invention can achieve spring properties substantially similar to those of a suspension bush having an intermediate member passing through a main rubber elastic body as disclosed in Related Art 1. The suspension bush 10 can also improve the durability to the input in the bending direction by substantially 15 times. Compared to a suspension bush having a bulging shape on an inner shaft member as disclosed in Related Art 2, the suspension bush 10 allows the spring constant in the torsional direction to be set by a substantially half while achieving the substantially similar spring constant in the direction perpendicular to the axis. The suspension bush 10 can also improve the durability to the input in the bending direction by substantially 1.5 times. It is thus demonstrated in the experiments that the suspension bush 10 having the structure according to the present invention can achieve the excellent spring properties and the excellent durability to the input in the bending direction.

It is also demonstrated in the experiments that the durability to the input in the torsional direction is improved by substantially 2.5 times in the suspension bush 10, compared to the suspension bush having the structure disclosed in Related Art 1. In addition to the effect from the thickness difference between the internal peripheral portion 20 and the external peripheral portion 22, this is considered because the projecting portion (support projection 36) to the axial end surface of the main rubber elastic body 16 in the intermediate member 32 is extremely small in the circumferential direction, compared to the structure in Related Art 1. Furthermore, this is also considered because the sufficiently secured thickness of the covered portion 24 reduces the binding of the intermediate member 32 on the axial end surface of the main rubber elastic body 16 and thus ensures a free length to a large extent.

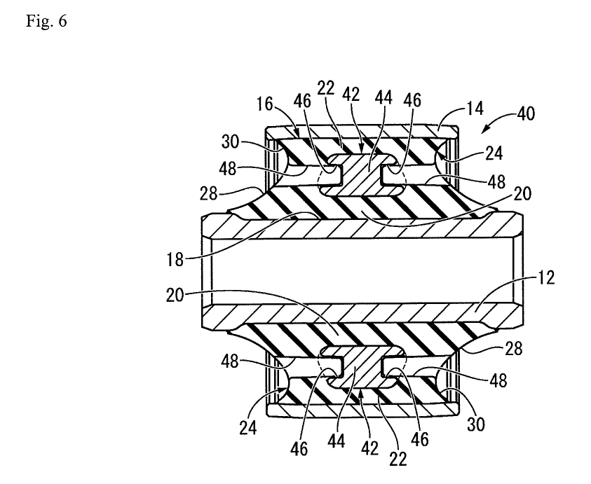

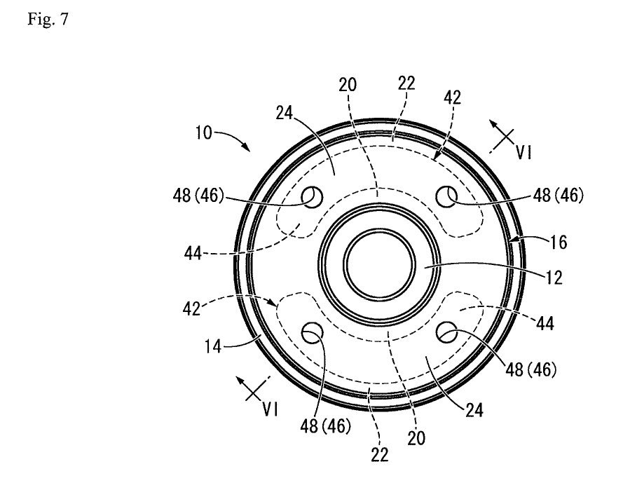

FIGS. 6 and 7 illustrate a suspension bush 40 as an anti-vibration bush having a structure according to a second embodiment of the present invention. In the explanations below, members and portions substantially same as those in the first embodiment are denoted with the same reference numerals in the drawings, and explanations thereof are omitted.

More specifically, the suspension bush 40 has a structure in which an inner shaft member 12 and an outer tubular member 14 are connected by a main rubber elastic body 16. An intermediate member 42 is attached to the main rubber elastic body 16.

The intermediate member 42 has a main body 44 harder than the main rubber elastic body 16 and having substantially the same shape as the main body 34 of the main rubber elastic body 16. The main body 44 has a substantially isosceles trapezoidal shape from a cross-sectional view, in which an internal peripheral portion has a larger axial size than an external peripheral portion. The main body 44 extends for a predetermined length of a less than a semi-perimeter.

Furthermore, the intermediate member 42 is provided with support recesses 46 each as a support in two circumferential side portions, where the support projections 36 project from the intermediate member 32 in the first embodiment. The support recesses 46 each have a small diameter and substantially circular cross section and extend in the axial direction. The support recesses 46 are each open to an axial end surface of the main body 44. The support recesses 46 are provided in a pair in the two circumferential side portions open to the respective axial end surfaces. Four support recesses 46 are thus provided in one main body 44. The diameter of each of the support recesses 46 is smaller than the radial width (vertical direction in FIG. 6) of the main body 44 as shown in FIG. 6.

Similar to the first embodiment, the intermediate member 42 having such a structure is disposed between radially opposite surfaces of the inner shaft member 12 and the outer tubular member 14 and is vulcanized and attached to the main rubber elastic body 16. Four through-holes 48 are provided in the main rubber elastic body 16 of the present embodiment. The through-holes 48 are provided in positions corresponding to the support recesses 46 of the intermediate member 42. In a state where the intermediate member 42 is embedded in and attached to the main rubber elastic body 16, the support recesses 46 are exposed externally through the through-holes 48. A substantially entirety of an internal peripheral surface of each of the support recesses 46 is covered by a thin rubber layer integrally provided with the main rubber elastic body 16.

In the suspension bush 40, the intermediate member 42 is positioned in a cavity of a mold by inserting support columns (not shown in the drawing) projecting from the mold of the main rubber elastic body 16 into the support recesses 46. A rubber material is filled in the cavity, and thereby the intermediate member 42 is provided in the state of being embedded in the main rubber elastic body 16. The four through-holes 48 of the main rubber elastic body 16 are provided as the support columns of the mold are removed from the vulcanized main rubber elastic body 16.

According to the suspension bush 40 having such a structure, attachment positions of the supports (support recesses 46) and the main rubber elastic body 16 are provided closer to the axial center than those in the suspension bush 10 of the first embodiment. Thus, the deformation amount of the main rubber elastic body 16 caused by tilting of the inner shaft member 12 and the outer tubular member 14 due to the input in a bending direction is reduced in the attachment portions of the main rubber elastic body 16, and thus a stress exerted on the main rubber elastic body 16 is reduced. Thereby, cracks are prevented from being caused in the main rubber elastic body 16 in the attachment portions to the intermediate member 42, thus further improving durability.

In addition, the intermediate member 42 of the present embodiment has a simple shape with no projection, compared to the intermediate member 32 of the first embodiment which is provided with the axially projecting support projections 36, thus allowing easy production and effective storage and transportation.

The embodiments of the present invention are explained as above. The present invention, however, is not limited to the specifics in the embodiments. For instance, the specific shape of the intermediate member may be adjusted according to required spring properties and durability performance. Specifically, the intermediate members 32 and 42 in the embodiments each have a flat and substantially isosceles trapezoidal shape having an axial size larger than a radial size from a cross-sectional view. Instead, the radial size may be larger than the axial size. The intermediate member is not necessarily be in an isosceles trapezoidal shape from a vertical cross-sectional view, for instance. Tilts of axial end surfaces (tapered surfaces 38) may be different from each other. In the case where the tilts of the internal tapered surfaces 28 of the main rubber elastic body 16 are different from each other on the two axial sides, an intermediate member having axial end surfaces tilting differently from each other may be employed so as to provide a substantially constant thickness of the covered portion 24 of the main rubber elastic body 16.

The number of supports is not particularly limited and may be determined to any number, provided that the main rubber elastic body 16 can be stably positioned to the mold at vulcanization. Setting the reduced number of the supports can more effectively improve the durability of the main rubber elastic body 16. Since the supports are provided in view of the balance of springs in the main rubber elastic body 16, it is desirable to be disposed symmetrically in an input direction of main vibration. The placement of the supports, however, is not particularly limited, either.

The intermediate members 32 and 42 are not necessarily biased toward the outer tubular member 14 in the radial direction. The intermediate members 32 and 42 may be disposed away for an equal distance from each of the inner shaft member 12 and the outer tubular member 14. Alternatively, the intermediate members 32 and 42 may be biased toward the inner shaft member 12.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An anti-vibration bush having an inner shaft member and an outer tubular member disposed external to the inner shaft member, the inner shaft member and the outer tubular member being connected by a main rubber elastic body, the anti-vibration bush comprising:
a pair of intermediate members harder than the main rubber elastic body, circumferentially extending for a predetermined length, and provided radially opposite to each other radially between the inner shaft member and the outer tubular member, wherein
the intermediate members are embedded in and attached to the main rubber elastic body, and
an axial size of an end surface on the inner shaft member side of each of the intermediate members is larger than an axial size of an end surface on the outer tubular member side of each of the intermediate members.

2. The anti-vibration bush according to claim 1, wherein, in the main rubber elastic body, a radial size of a portion between the inner shaft member and each intermediate member is larger than a radial size of a portion between the outer tubular member and each intermediate member.

3. The anti-vibration bush according to claim 1, wherein the pair of intermediate members are each provided with a support in a position circumferentially out of a mutually opposing radial line and exposed externally from the main rubber elastic body, the support supporting and positioning the intermediate member in molding of the main rubber elastic body.

4. The anti-vibration bush according to claim 2, wherein the pair of intermediate members are each provided with a support in a position circumferentially out of a mutually opposing radial line and exposed externally from the main rubber elastic body, the support supporting and positioning the intermediate member in molding of the main rubber elastic body.

5. The anti-vibration bush according to claim 1, wherein an axial length of the main rubber elastic body is greater in an internal peripheral portion than in an external peripheral portion.

6. The anti-vibration bush according to claim 2, wherein an axial length of the main rubber elastic body is greater in an internal peripheral portion than in an external peripheral portion.

7. The anti-vibration bush according to claim 3, wherein an axial length of the main rubber elastic body is greater in an internal peripheral portion than in an external peripheral portion.

8. The anti-vibration bush according to claim 4, wherein an axial length of the main rubber elastic body is greater in an internal peripheral portion than in an external peripheral portion.
